(19) United States
(12) Patent Application Publication
(10) Pub. No.: US 2025/0061370 A1
(43) Pub. Date: Feb. 20, 2025

(54) Latency-Reduced Quantum Error Detection Graph Decoding

(71) Applicant: Google LLC, Mountain View, CA (US)

(72) Inventors: Noah John Shutty, Santa Monica, CA (US); Austin Fowler, Los Angeles, CA (US)

(21) Appl. No.: 18/449,314

(22) Filed: Aug. 14, 2023

(51) Int. Cl. G06N 10/70

(52) U.S. Cl. CPC G06N 10/70

(57) ABSTRACT

Systems and methods for error detection in a quantum computing system are provided. In one example, the method includes obtaining a multidimensional quantum error detection graph. The multidimensional quantum error detection graph represents one or more quantum error detection measurements across a time period. The method includes determining a partitioning scheme and a fusing scheme for the multidimensional quantum error detection graph based at least in part on a decoding latency and a fusing latency. The method includes partitioning the multidimensional quantum error detection graph into a plurality of blocks based at least in part on the partitioning scheme. The method includes decoding each of the plurality of blocks. The method includes fusing the plurality of blocks into a decoded detection graph based at least in part on the fusing scheme. The method includes operating a quantum computing system based at least in part on the decoded detection graph.

### FIELD

The present disclosure relates generally to quantum computing systems and more particularly to error correction for quantum computing systems.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a|0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes obtaining, by one or more computing devices, a multidimensional quantum error detection graph. The multidimensional quantum error detection graph represents one or more quantum error detection measurements across a time period. The method includes determining, by the one or more computing devices, a partitioning scheme and a fusing scheme for the multidimensional quantum error detection graph based at least in part on a decoding latency and a fusing latency. The method includes partitioning, by the one or more computing devices, the multidimensional quantum error detection graph into a plurality of blocks based at least in part on the partitioning scheme. The method includes decoding, by the one or more computing devices, each of the plurality of blocks. The method includes fusing, by the one or more computing devices, the plurality of blocks into a decoded detection graph based at least in part on the fusing scheme. The method includes operating a quantum computing system based at least in part on the decoded detection graph.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example embodiment of a quantum computing system according to example embodiments of the present disclosure.

FIG. 2 depicts an overview of an example decoding process for quantum error correction according to example embodiments of the present disclosure.

FIG. 3 depicts example partitioning schemes for partitioning a multidimensional quantum error detection graph according to example embodiments of the present disclosure.

FIG. 4 depicts a representation of an example fusion tree data structure according to example embodiments of the present disclosure.

FIG. 5 depicts a representation of an example fusion tree data structure according to example embodiments of the present disclosure.

FIG. 6 depicts example partitioning schemes resulting from a latency optimized fusion tree (LOFT) process according to example embodiments of the present disclosure.

FIG. 7 depicts a flow chart of an example method according to example embodiments of the present disclosure.

FIG. 8 depicts a flow chart of an example method according to example embodiments of the present disclosure.

FIG. 9 depicts a flow chart of an example method according to example embodiments of the present disclosure.

FIG. 10 depicts a block diagram of an example computing system according to example embodiments of the present disclosure.

### DETAILED DESCRIPTION

Example aspects of the present disclosure are directed to systems, devices, and computer-implemented methods for error detection in quantum computing systems. More particularly, example aspects are directed to the decoding of multidimensional quantum error detection graphs for use in a quantum error correction process. For instance, a quantum error correction process may include reducing the error rate of logical qubits of a quantum computing system by detecting and tracking physical errors within the system. Uncorrected physical errors can generate errors in the logical qubit, but the quantum computing system may be configured to permit identification and tracking of the physical errors. In this way, operations can be implemented (e.g., at a classical processing level) to mitigate effects of such physical errors and lead to improved performance of a quantum computing system.

For instance, in some embodiments, each logical qubit may be encoded in a plurality of physical qubits. For instance, a code (e.g., a topological code, such as a surface code) may encode a logical qubit using a plurality of data qubits and a plurality of measurement qubits. The measurement qubits may be configured such that their respective states can be measured to detect physical errors (e.g., errors of the physical qubits and/or of their measurement). These error detection measurements can be measured over a time period and subsequently combined to build an error detection graph, with the weights of the graph links corresponding to an associated error probability.

Over time, detection graphs may become sizable and cumbersome, and the process of decoding these graphs becomes costly (e.g., in terms of time or latency). Latency of decoding may be defined as a time interval between the time in which all measurements needed to determine a logical observable first become available to the time a prediction of the observable is available. Latency of decoding will limit the logical clock speed of a fault-tolerant quantum computer. As such, there is a need within the field for a process capable of effectively and efficiently decoding a detection graph so timely operations may be conducted on a quantum computing system to correct potential errors.

Techniques for leveraging error correlations may be computationally expensive. For example, some techniques require processing all error detection measurements to determine a first set of results, adjusting the probabilities of certain error detection measurements according to known correlations among the first set of results, and then re-processing all error detection measurements with the adjusted probabilities. For real-time tracking of quantum errors, intervals between subsequent error detection measurements are generally on the scale of microseconds, and the iterative global processing of the entire set of error detection measurements can result in substantial computational overhead.

Advantageously, systems and methods according to example aspects of the present disclosure allow for the creation and operation of a decoding system that can parallelize its work across space and time by partitioning a quantum error detection graph into separate decoding blocks that can be independently decoded and fusing the results from each block into one overall decoding prediction that can subsequently be used to operate a quantum computing system.

For example, in some embodiments, a computer-implemented method can include the process by which one or more computing devices receive a multidimensional quantum error detection graph. The quantum error detection graph may represent quantum error detection measurements across a time period. The computer-implemented method can partition the quantum error detection graph into a plurality of blocks, decode the individual blocks, and fuse the individual blocks together to obtain a decoded graph, which can then be used to operate the quantum computing system.

More specifically, in some examples, a plurality of fusion tree data structures may be generated for the detection graph. Each fusion tree data structure may include a partitioning scheme for partitioning the detection graph into a plurality of blocks (e.g., right rectangular prisms) and a schedule of fusions. The latency of each fusion tree may be estimated using two functions: (1) a function for estimating decoding time for each block; and (2) a function for estimating fusing time for two or more blocks. A latency optimal fusion tree (LOFT) process may be implemented to determine a fusion tree that reduces the latency of the decoder.

The inputs to the LOFT process may include the quantum error detection graph along with at least one arbitrary function that estimates the costs of (a) decoding within a quantum error detection block and (b) fusing two adjacent quantum error detection blocks. The LOFT process may determine from a range of partitioning and fusing schemes for the weighted quantum error detection graph which partitioning and fusing scheme will have the best latency and select the partitioning and fusing scheme for decoding the quantum error detection block.

Systems and methods according to example aspects of the present disclosure can provide for a number of technical effects and benefits, including but not limited to improvements to computing technology (e.g., quantum computing technology). For instance, example aspects of the present disclosure can provide for reduced evaluation time of error information and/or evaluating error information in a scalable manner. Example aspects of the present disclosure also provide a unique focus on low latency, which is an important aspect of efficient quantum computers. This is especially beneficial in real-world (e.g., noisy) quantum computing applications, which present a need for rapid, real-time error tracking on an increasing number of qubits.

With reference now to the Figures, example embodiments of the present disclosure will be discussed in further detail.

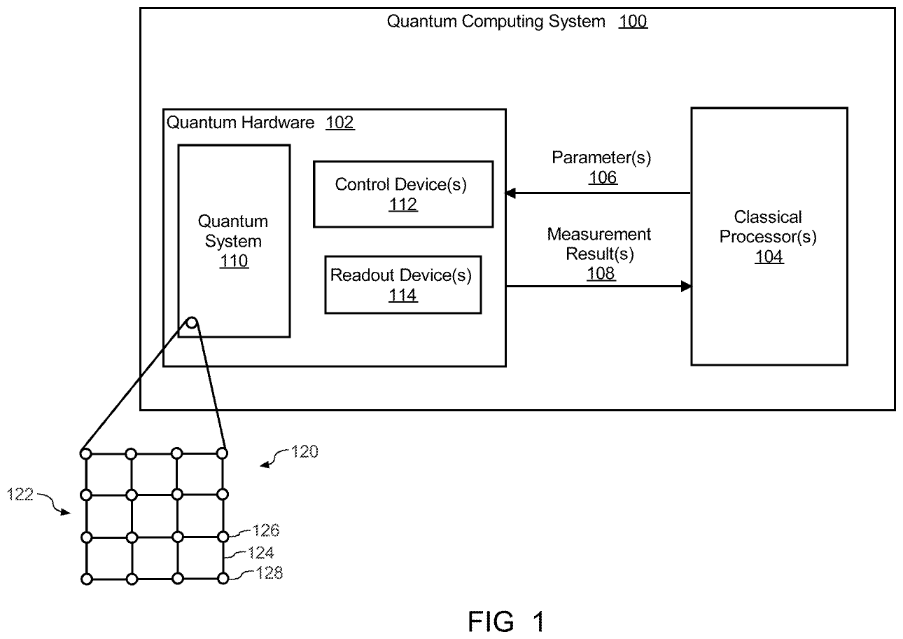

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum hardware 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

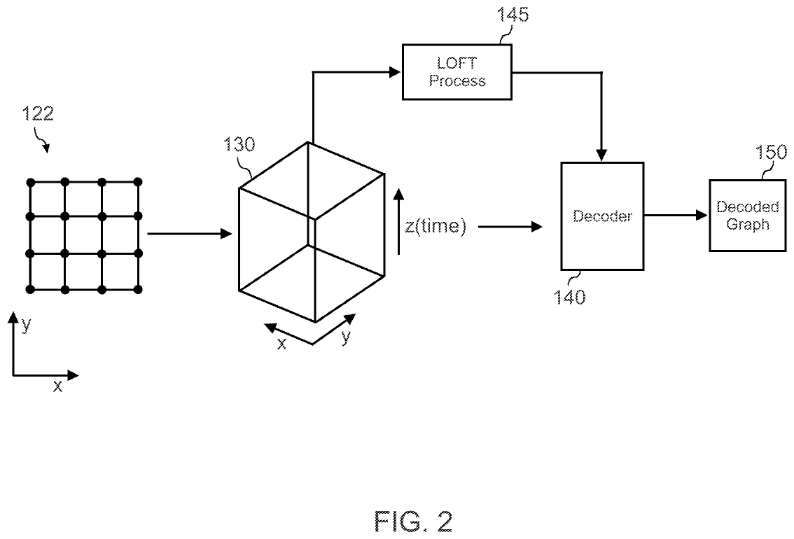

In some examples, the qubit grid 122 may act as a quantum surface code. As illustrated in FIG. 2, qubit grid 122 can be an interlaced qubit grid of one or more data qubits 126 and/or one or more measurement qubits 128. For instance, some of all of the data qubits 126 can be used to implement a time series of quantum gate operations defining a quantum algorithm across some or all data qubits 126. A data qubit 126 can be surrounded by measurement qubits 128. Additionally and/or alternatively, a measurement qubit 128 can be positioned within a square or other surface defined by two or more (e.g., four) data qubits 126. The measurement qubits 128 can be configured to provide readouts and/or measure errors (e.g., parity) in outputs of the data qubits 126. Error can be detected based on parity or differences between the measurement qubits 128 surrounding or near a data qubit 126.

FIG. 1 depicts one example quantum computing system that can be used to implement the methods and operations according to example aspects of the present disclosure. Other quantum computing systems can be used without deviating from the scope of the present disclosure.

FIG. 2 depicts an overview of at least a portion of an error detection process for a quantum computing system (e.g., the quantum computing system of FIG. 1) according to example embodiments of the present disclosure. FIG. 2 depicts example generation of an error detection graph 130 from an example qubit grid 122 (e.g., a surface code). The error detection graph 130 may have an x-axis and y-axis corresponding to the x-y spatial dimensions of the surface code. The error detection graph 130 may have a z-axis corresponding to time. The error detection graph 130 may have nodes corresponding to detection events (e.g., endpoints of mismatched parity). For instance, in some implementations, a computing system can receive error information including coordinates describing endpoints of mismatched parity (e.g., between data qubits and/or measurement qubits). This may be used to build the error detection graph 130. The error detection graph 130 may be provided to a decoder 140 which may decode portions of the error detection graph 130 in parallel. Decoding the error detection graph 130 may include, in some examples, solving for a minimum cost alternating path between pairs of endpoints to provide a decoded graph 150. The minimum cost alternating path can be indicative of a most likely source of error resulting in the mismatched parity at the endpoints. Thus, the minimum cost alternating path can be indicative of a position of the qubit at which an error has occurred. In some cases, these errors can propagate through a quantum computation, and so prompt detection and/or correction can be beneficial.

According to example aspects of the present disclosure, a quantum error detection graph 130 may be partitioned into blocks for parallel processing by the decoder 140. The blocks may be decoded in parallel and fused back together to reduce latency. According to examples aspects of the present disclosure, a LOFT process 145 may be implemented, for instance, by a classical computing system, to determine the best way to partition the error detection graph into blocks (e.g., rectangular prisms), decode each individual block, and fuse the blocks back together to reduce latency of the decoding process.

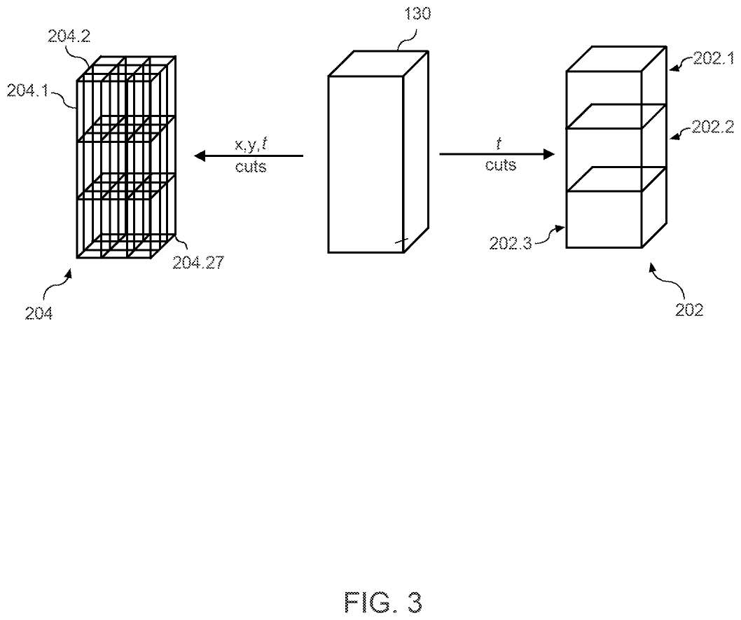

FIG. 3 depicts example partitioning of an error detection graph 130. More particularly, FIG. 3 depicts two different partitioning schemes for partitioning the error detection graph 130. In partitioning scheme 202, the error detection graph 130 is partitioned into blocks 202.1, 202.2, 202.3 . . . 202.n by partitioning in the time dimension (z-axis). Each of the blocks 202.1, 202.2, 202.3, . . . 202.n may be decoded (e.g., in parallel) and fused back together to provide a decoded error detection graph. In the partitioning scheme 202, each block 202.1, 202.2, 202.3 . . . 202.n have equal size.

In partitioning scheme 204, the error detection graph 130 is partitioned into blocks 204.1, 204.2, . . . 204.27, . . . 204.n by portioning in the time dimension (z-axis) as well as in the spatial dimensions (x-dimension and y-dimension) associated with the qubit grid 122 (e.g., surface code). Each of the blocks 204.1, 204.2, . . . 204.27 . . . 204.n may be decoded (e.g., in parallel) and fused back together to provide a decoded error detection graph. In the partitioning scheme 204, each block 204.1, 204.2, . . . 204.27, . . . 204.n have equal size.

FIG. 3 depicts two example partitioning schemes for purposes of illustration and discussion. Those of ordinary skill in the art, using the disclosures provided herein, will understand that the error detection graph 130 may be partitioned and fused back together in a variety of ways. According to example aspects of the present disclosure, a LOFT process may be implemented to determine an optimal way to partition and fuse blocks to reduce latency in processing the error detection graph 130.

Each block 202.1, 202.2, 202.3 . . . 202.n or block 204.1, 204.2, . . . 204.27, . . . 204.n may have a volume. Moreover, there may be an area between adjacent blocks that are fused together. For instance, referring to block 202.1 as an example, the block 202.1 may have a volume V and a boundary area A for fusing with block 202.2. The cost of decoding a block with volume V is c1*V. The cost of fusing blocks having a boundary area A between the blocks is c2*A.

As used herein, the individual decoding blocks are illustrated as right rectangular prisms. Those of ordinary skill in the art, using the disclosures provided herein, will understand that the blocks may have other suitable shapes without deviating from the scope of the present disclosure.

The LOFT process may determine which fusion tree (e.g., partitioning scheme and fusion scheme) may provide the best latency (e.g. least latency) for decoding an error detection graph. The inputs of the LOFT process may be the error detection graph along with two functions that estimate costs/latency for decoding a block and costs/latency for fusing two blocks together. One example function for estimating costs/latency associated with fusing blocks may provide a constant latency/cost for fusing two blocks. Another example function for estimating costs/latency associated with fusing blocks may provide a cost/latency proportional to the boundary area A between two blocks. The decoding costs/latency associated with decoding blocks may be determined, for instance, using a union-find based algorithm and/or a minimum weight perfect matching (MWPM) algorithm.

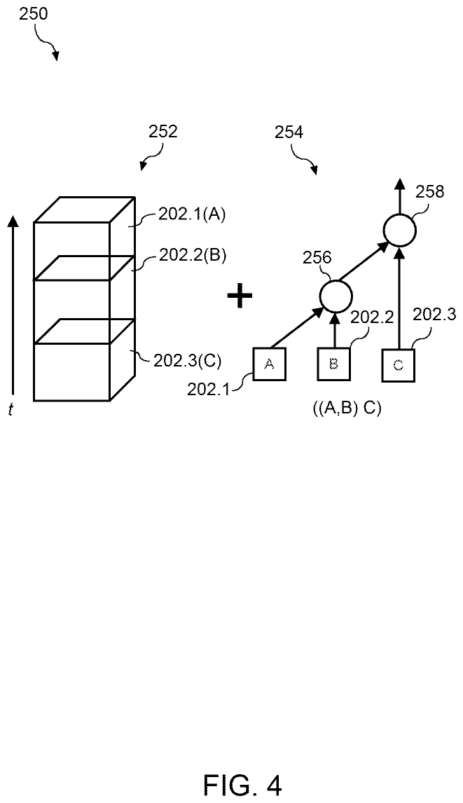

According to example aspects of the present disclosure, the LOFT process may determine a plurality of fusion tree data structures for an error detection graph. FIG. 4 depicts a representation of an example fusion tree 250 according to example aspects of the present disclosure. Each fusion tree 250 includes two components. The first component is the partitioning scheme 252 for partitioning the error detection graph 130 (e.g., partitioning scheme 202) into a plurality of blocks. The second component is a tree data structure 254 that specifies a partial ordering in which the blocks (e.g., blocks 202.1, 202.2, and 202.3) are fused together.

As shown, the blocks 202.1 (Block A), 202.2 (Block B), and 202.3 (Block C) are represented by leaf nodes in the tree data structure 254. In the example of FIG. 4, blocks 202.1 and 202.2 are fused to generate a fused block represented by node 256. The fused block represented by node 256 is then fused with block 202.3 to generate the fused block represented by node 258. Aspects of the present disclosure are discussed with reference to binary trees for purposes of illustration and discussion. Those of ordinary skill in the art, using the disclosures provided herein, will understand that aspects of the present disclosure may be implemented with tree structures of any degree (e.g., ternary trees, etc.).

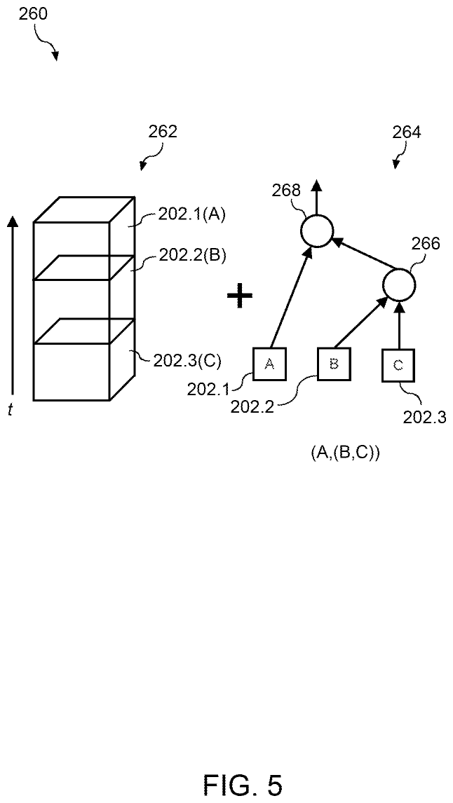

There may be multiple fusion trees for each partitioning scheme. For instance, FIG. 5 depicts another example fusion tree 260 associated with the partitioning scheme 252. In the example of FIG. 5, the fusion tree 260 includes two components. The first component is the partitioning scheme 252 for partitioning the error detection graph 130 (e.g., partitioning scheme 202) into a plurality of blocks. The second component is a tree data structure 264 that specifies a partial ordering in which the blocks (e.g., blocks 202.1, 202.2, and 202.3) are fused together.

As shown, the blocks 202.1 (Block A), 202.2 (Block B), and 202.3 (Block C) are represented by leaf nodes in the tree data structure 264. In the example of FIG. 5, blocks 202.2 and 202.3 are fused to generate a fused block represented by node 266. The fused block represented by node 266 is then fused with block 202.1 to generate the fused block represented by node 268.

Aspects of the present disclosure are directed to determining a fusion tree that provides optimal latency for decoding an error detection graph. For instance, given a detection graph G=(V, E), a fusion tree W for G is a tuple W=(L, T), where:
(1) L is a list L=[S₁, . . . , Sₙ] of disjoint subsets of V whose union is V (the set of detector vertices in the matching graph). This is an example partitioning scheme.
(2) A rooted tree T with root node labeled r and n leaf nodes labeled 1, . . . , n. This is the tree data structure.

A fusion tree W specifies a procedure for decoding on the graph G. The Sᵢ are the blocks. The n leaf nodes correspond to S₁, . . . , Sₙ, respectively. Each block may be decoded individually, starting as soon as its final measurement is available. The blocks are then fused according to T, where each internal node corresponds to a fusion of its children.

To estimate the latency of decoding with a fusion tree W=(L, T), the time to decode within a block and the time to fuse two blocks together is estimated. For instance, suppose that each vertex v∈V has a time coordinate t(v) at which it becomes available. For convenience, given subset S⊂V, define

t(S):=maxv∈S t(v)

The latency of decoding a subset S of V is defined as the difference between t(S) and the time at which the decoding of S is completed. Suppose we have access to two functions:

(1) Tdecode(S) returns the time to decode a set S.

(2) Tfuse(S1, S2) returns the time to fuse the outputs of decoding on S1 and S2 separately into an output of decoding on S1␣S2.

Tfuse and Tdecode can be arbitrary functions. As discussed above, Tfuse may provide a constant latency/cost for fusing two blocks. Another example function for estimating costs/latency associated with fusing blocks may provide a cost/latency proportional to the boundary area A between two blocks. Tdecode may include, for instance, a union-find based algorithm and/or a minimum weight perfect matching (MWPM) algorithm. In some examples, empirically-observed detection frequencies for each vertex in G can be used to better estimate Tfuse and Tdecode. In some examples, Tfuse and Tdecode may include a lookup table of latency/costs based on, for instance, size of blocks or other parameters.

The latency W of a fusion tree may be determined as follows. Each vertex v∈T corresponds to an intermediate decoding output for some subset S(v). This output will become available at some time, as follows. A leaf node of T, labeled i, corresponds to decoding within block Si. This process may start exactly at t(Si) (i.e., as soon as possible). Then the output will become available at time t(i):=t(Si)+Tdecode(Si).

An interior node v∈T with children c1, c2 corresponds to a fusion of the outputs of those children. This process will start at max(t(c1), t(c2)) and complete in time Tfuse(S(c1), S(c2)). Therefore, t(v):=max(t(c1), t(c2))+Tfuse(S(c1), S(c2)).

The latency of decoding the graph G with a fusion tree W=(L, T) is denoted Latency(W). From the preceding, Latency(W)=t(r)−t(V), where r is the root node of T. Given W and G, it is easy to compute Latency(W). We can use recursion starting from the root node, or simply build up t(v) for each node v∈T starting from the leaves.

In some examples, the LOFT process may choose W that minimizes Latency(W) for some G. One example LOFT process algorithm is provided below:

Consider an example where T is a binary tree and all interior nodes correspond to fusing right rectangular prisms to produce a right rectangular prism. Two functions to estimate latency for fusion Tfuse, Tdecode, have been defined for t: V→[0, ∞) as defined above. The min_latency(S) may be defined recursively in pseudocode as follows:

```
def min_latency(S):
  # Consider decoding S without a cut
  t_best = t(S) + T_decode(S)
  # Consider all ways of cutting S in two
  for each Cut along x, y, or t axis:
    S1, S2 = Cut.apply(S)
      t_1 = t(S1) + min_latency(S1)
      t_2 = t(S2) + min_latency(S2)
      t_this_cut = T_fuse(Cut.area)
      t_best = min(t_best, t_this_cut)
  return t_best
```

Dynamic programming may be used in some examples to take advantage of the fact that there are only polynomially many subsets S (i.e., the rectilinear prisms in V). The resulting algorithm is as follows:

```
def min_latency_dp(S, memo={ }):
  # Check the memo
  if S in memo:
    return memo[S]
  # Consider decoding S without a cut
  t_best = t(S) + T_decode(S)
  # Consider all ways of cutting S in two
  for each Cut along x, y, or t axis:
    S1, S2 = Cut.apply(S)
    t_1 = t(S1) + min_latency_dp(S1, memo=memo)
    t_2 = t(S2) + min_latency_dp(S2, memo=memo)
    t_this_cut = T_fuse(Cut.area)
    t_best = min(t_best, t_this_cut)
  memo[S] = t_best
  return t_best
```

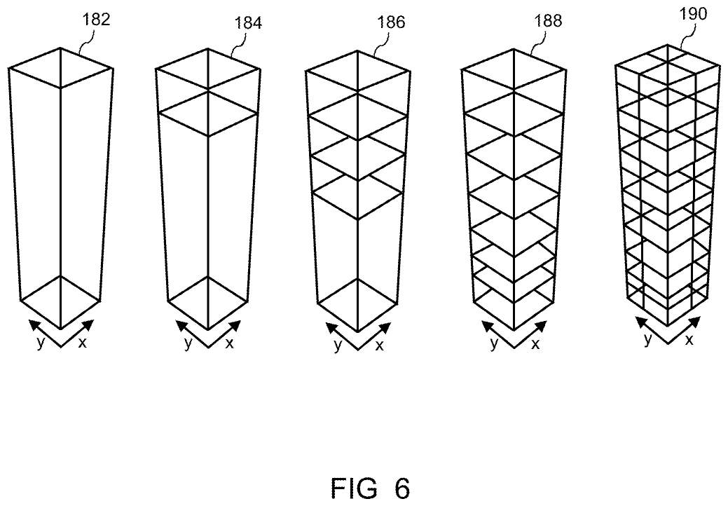

FIG. 6 depicts example partitioning schemes that may be determined by a LOFT process according to example embodiments of the present disclosure. As demonstrated in FIG. 6, a variety of possible solutions may be determined. For instance, partitioning scheme 182 includes no partitioning. Partitioning scheme 184 includes partitions along the time dimension into unequal block sizes. Partitioning scheme 186 includes partitions along the time dimension into unequal block sizes. Partitioning scheme 188 includes partitions along the time dimension into unequal block sizes. Partitioning scheme 190 includes partitions along the spatial (x- and/or y-dimensions) and time dimension into unequal block sizes.

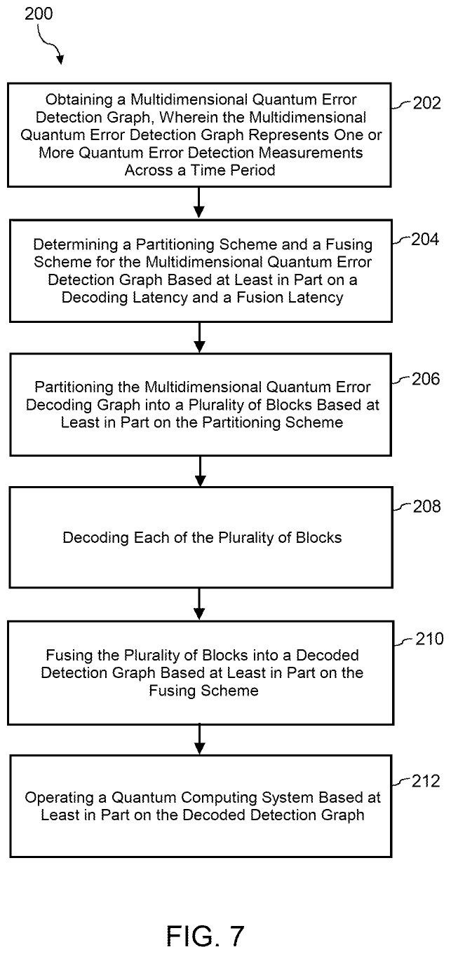

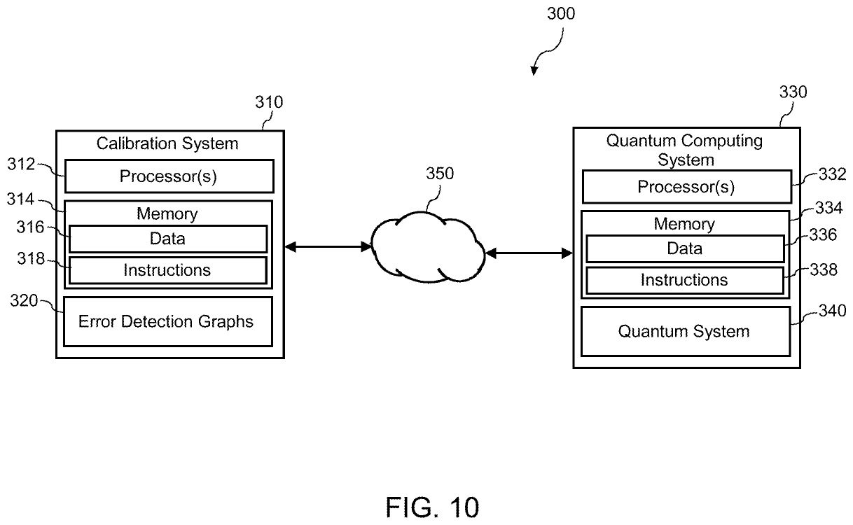

FIG. 7 depicts a flow chart of an example method 200 according to example embodiments of the present disclosure. The operations may be implemented by a quantum and/or classical computing system. For instance, the operations may be implemented by the computing system 300 (e.g., one or more processors 312 of the computing system) depicted in FIG. 10. The method 200 illustrates operations performed in a particular order for purposes of illustration and discussion. Those of ordinary skill in the art, using the disclosures provided herein, will understand the various operations of any of the methods described herein can be adapted, modified, rearranged, omitted, include steps not illustrated, and/or expanded in various ways without deviating from the scope of the present disclosure.

At (202), the method includes obtaining a multidimensional quantum error detection graph. The multidimensional quantum error detection graph may represent one or more quantum error detection measurements across a time period. For instance, the method may include obtaining the quantum error detection graph 130. The quantum error detection measurements may be derived from a surface code. For instance, the quantum error detection measurements may result from parity between qubits (e.g., data qubits 126 and measurement qubits 128) in a surface code.

At (204), the method includes determining a partitioning scheme and a fusing scheme for the multidimensional quantum error detection graph based at least in part on a decoding latency and a fusing latency. For instance, the method may implement a LOFT process 145 as described with reference to FIGS. 2-6 to determine the partitioning scheme and the fusing scheme to reduce latency.

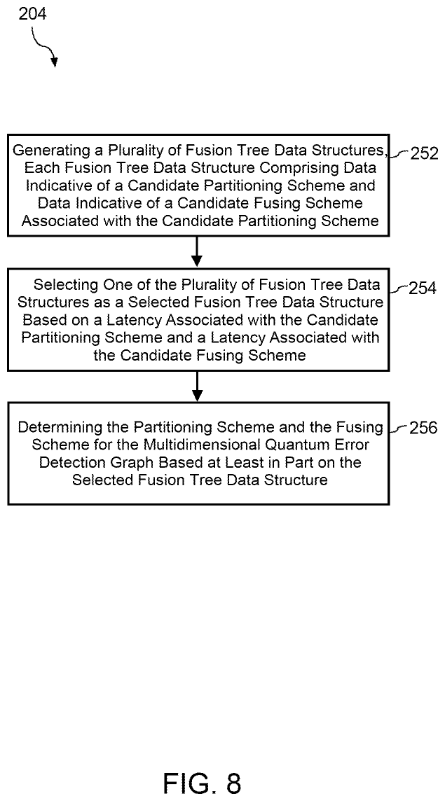

FIG. 8 depicts a flow chart of determining a partitioning scheme and a fusing scheme according to example embodiments of the present disclosure. The operations may be implemented by a quantum and/or classical computing system. For instance, the operations may be implemented by the computing system 300 (e.g., one or more processors 312 of the computing system) depicted in FIG. 10. FIG. 8 illustrates operations performed in a particular order for purposes of illustration and discussion. Those of ordinary skill in the art, using the disclosures provided herein, will understand the various operations of any of the methods described herein can be adapted, modified, rearranged, omitted, include steps not illustrated, and/or expanded in various ways without deviating from the scope of the present disclosure.

At (252), determining a partitioning scheme and a fusing scheme may include generating a plurality of fusion tree data structures. Each fusion tree data structure may include data indicative of a candidate partitioning scheme and data indicative of a candidate fusing scheme associated with the candidate partitioning scheme. Example fusion tree data structure are discussed with reference to FIGS. 4 and 5.

At (254), determining a partitioning scheme and a fusing scheme may include selecting one of the plurality of fusion tree data structures as a selected fusion tree data structure based on a decoding latency associated with the candidate partitioning scheme and a fusing latency associated with the candidate fusing scheme. For instance, one or more functions may be used to estimate a latency associated with each candidate partition scheme and a latency associated with a candidate fusing scheme. One example function for estimating costs/latency associated with fusing blocks may provide a constant latency/cost for fusing two blocks. Another example function for estimating costs/latency associated with fusing blocks may provide a cost/latency proportional to the boundary area A between two blocks. The decoding costs/latency associated with decoding blocks may be determined, for instance, using a union-find based algorithm and/or a minimum weight perfect matching (MWPM) algorithm. In some examples, the candidate fusion tree data structure with least latency may be selected as the selected fusion tree data structure.

At (256), determining a partitioning scheme and a fusing scheme may include determining the partitioning scheme and the fusing scheme for the multidimensional quantum error detection graph based at least in part on the selected fusion tree data structure. For instance, the candidate partitioning scheme and the candidate fusing scheme associated with the selected fusion tree data structure may be determined as the partitioning scheme and the fusing scheme respectively.

Referring back to FIG. 7 at (206), the method 200 may include partitioning the multidimensional quantum error detection graph into a plurality of blocks based at least in part on the partitioning scheme. The blocks may be right rectangular prisms in some examples. However, the blocks may have other suitable shapes without deviating from the scope of the present disclosure. In some examples, the blocks may have equal size as illustrated in FIG. 3. In some examples, the blocks may have unequal sizes as illustrated in FIG. 6. The partitioning scheme may partition the quantum error detection graph in the time dimension. In some examples, the partitioning scheme may partition the quantum error detection graph in the spatial (e.g., x- and/or y-dimensions) and the time dimension.

At (208), the method may include decoding each of the plurality of blocks. For instance, decoding each of the blocks may include solving for a minimum cost alternating path between pairs of endpoints to provide a decoded graph. The minimum cost alternating path can be indicative of a most likely source of error resulting in the mismatched parity at the endpoints. Thus, the minimum cost alternating path can be indicative of a position of the qubit at which an error has occurred.

At (210), the method may include fusing plurality of blocks into a decoded detection graph based at least in part on the fusing scheme. The fusing scheme may be the fusing scheme determined at (204) using, for instance, the LOFT process.

At (212), the method may include operating a quantum computing system based at least in part on the decoded detection graph. For instance, the method may include implementing one or more error correction processes based on the decoded detection graph.

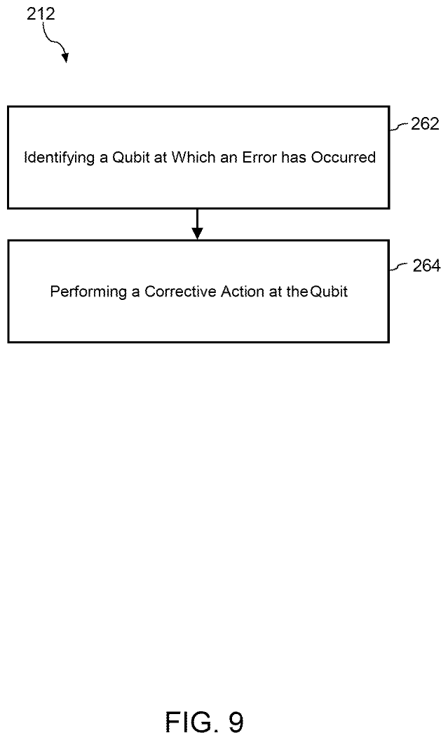

FIG. 9 depicts a flow chart diagram of one example error correction process according to example embodiments of the present disclosure. The operations may be implemented by a quantum and/or classical computing system. For instance, the operations may be implemented by the computing system 300 (e.g., one or more processors 312 of the computing system) depicted in FIG. 10. FIG. 9 illustrates operations performed in a particular order for purposes of illustration and discussion. Those of ordinary skill in the art, using the disclosures provided herein, will understand the various operations of any of the methods described herein can be adapted, modified, rearranged, omitted, include steps not illustrated, and/or expanded in various ways without deviating from the scope of the present disclosure.

At (262), operating the quantum computing system may include identifying one or more qubit(s) at which an error has occurred from the decoded detection graph. As discussed above, the decoded detection graph may include data indicative of a position of the qubit at which an error has occurred.

At (264), operating the quantum computing system may include performing a corrective action at the qubit. In some examples, the corrective action may include resetting the qubit, calibrating the qubit, implementing a quantum gate at the qubit to compensate for the error, or other suitable quantum computing operation. In some examples, the corrective action may include implementing a classical computing process to compensate for the error at the qubit (e.g., modifying an output to compensate for the error).

FIG. 10 depicts a block diagram of an example computing system 300 that can be used to implement the systems and methods according to example embodiments of the present disclosure, such as the methods discussed with reference to FIGS. 7-9. The system 300 includes a classical computing system 310 and a quantum computing system 330 that are communicatively coupled over a network 350. One or more aspects of any of the methods described herein can be implemented on the classical computing system 310 and/or the quantum computing system 330.

The classical computing system 310 can include any type of computing device (e.g., classical computing device). The classical computing system 310 includes one or more processors 312 and a memory 314. The one or more processors 312 can include any suitable processing device (e.g., a processor core, a microprocessor, an ASIC, a FPGA, a controller, a microcontroller, etc.) and can be one processor or a plurality of processors that are operatively connected. The memory 314 can include one or more non-transitory computer-readable storage mediums, such as RAM, ROM, EEPROM, EPROM, flash memory devices, magnetic disks, etc., and combinations thereof. The memory 314 can store data 316 (e.g., qubit parameters, measurements, etc.) and instructions 318 which are executed by the processor 312 to cause the classical computing system 310 to perform operations, such as one or more aspects of any of the method disclosed herein. The classical computing system 310 can be configured to process error information (e.g., error detection graphs 320) obtained by measuring outputs of a quantum system (e.g., quantum system 340) to identify errors in quantum computations according to example embodiments of the present disclosure.

The quantum computing system 330 includes one or more processors 332 and a memory 334. The one or more processors 332 can include suitable processing device (e.g., a processor core, a microprocessor, an ASIC, a FPGA, a controller, a microcontroller, etc.) and can be one processor or a plurality of processors that are operatively connected. The memory 334 can include one or more non-transitory computer-readable storage mediums, such as RAM, ROM, EEPROM, EPROM, flash memory devices, magnetic disks, etc., and combinations thereof. The memory 334 can store data 336 and instructions 338 which are executed by the processor 332 to cause the quantum computing system 330 to perform operations, such as implementation of a quantum circuit having one or more quantum gates on a quantum system 340 having a plurality of qubits and obtaining associated measurements (e.g., error detection graphs 320). The quantum computing system 330 can be similar to the quantum computing system discussed and described with reference to FIG. 1. Other suitable quantum computing systems can be used without deviating from the scope of the present disclosure.

The network 350 can be any type of communications network, such as a local area network (e.g., intranet), wide area network (e.g., Internet), or some combination thereof and can include any number of wired or wireless links. In general, communication over the network 350 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). In some implementations, the network 350 may be omitted such that the classical computing system 310 is in direct signal communication with quantum computing system 330.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs (e.g., one or more modules of digital and/or quantum computer program instructions encoded on a tangible non-transitory storage medium for execution by, or to control the operation of, data processing apparatus). The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit (i.e., a system that defines the unit of quantum information). It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc..

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A computer-implemented method, the method comprising:
obtaining, by one or more computing devices, a multidimensional quantum error detection graph, wherein the multidimensional quantum error detection graph represents one or more quantum error detection measurements across a time period;
determining, by the one or more computing devices, a partitioning scheme and a fusing scheme for the multidimensional quantum error detection graph based at least in part on a decoding latency and a fusing latency;
partitioning, by the one or more computing devices, the multidimensional quantum error detection graph into a plurality of blocks based at least in part on the partitioning scheme;
decoding, by the one or more computing devices, each of the plurality of blocks;
fusing, by the one or more computing devices, the plurality of blocks into a decoded detection graph based at least in part on the fusing scheme; and
operating a quantum computing system based at least in part on the decoded detection graph.

2. The computer-implemented method of claim 1, wherein the quantum error detection measurements are obtained from a surface code comprising a plurality of measurement qubits and a plurality of data qubits.

3. The computer-implemented method of claim 1, wherein the partitioning scheme partitions the multidimensional quantum error detection graph in a time dimension.

4. The computer-implemented method of claim 1, wherein the partitioning scheme partitions the multidimensional quantum error detection graph in one or more spatial dimensions.

5. The computer-implemented method of claim 1, wherein determining, by the one or more computing devices, a partitioning scheme and a fusing scheme comprises:
generating, by the one or more computing devices, a plurality of fusion tree data structures, each fusion tree data structure comprising data indicative of a candidate partitioning scheme and data indicative of a candidate fusing scheme associated with the candidate partitioning scheme;
selecting, by the one or more computing devices, one of the plurality of fusion tree data structures as a selected fusion tree data structure based on a latency associated with the candidate partitioning scheme and a latency associated with the candidate fusing scheme; and
determining, by the one or more computing devices, the partitioning scheme and the fusing scheme for the multidimensional quantum error detection graph based at least in part on the selected fusion tree data structure.

6. The computer-implemented method of claim 5, wherein the data indicative of the candidate fusing scheme is represented in a tree data structure.

7. The computer-implemented method of claim 6, wherein the tree data structure comprises a plurality of leaf nodes, each of the plurality of leaf nodes representing one of a plurality of blocks associated with the candidate partitioning scheme, the tree data structure comprising one or more nodes representing a fusing of two or more of the plurality of blocks associated with the candidate partitioning scheme.

8. The computer-implemented method of claim 1, wherein decoding the plurality of blocks comprises decoding at least a portion of the plurality of blocks in parallel.

9. The computer-implemented method of claim 1, wherein fusing the plurality of blocks comprises fusing at least a portion of the plurality of blocks in parallel.

10. The computer-implemented method of claim 1, wherein operating the quantum computing system based at least in part on the decoded detection graph comprising:
identifying, by one or more computing devices, a qubit at which an error has occurred; and
performing, by the one or more computing devices, a corrective action at the qubit.

11. The method of claim 1, wherein the plurality of blocks are of equal size.

12. The method of claim 1, wherein the plurality of blocks are of unequal size.

13. A quantum computing system, comprising:
a surface code comprising a plurality of qubits;
one or more processors;
one or more memory devices storing computer-readable instructions that when executed by the one or more processors cause the one or more processors to perform operations, the operations comprising:
obtaining a multidimensional quantum error detection graph, wherein the multidimensional quantum error detection graph represents one or more quantum error detection measurements across a time period;
determining a partitioning scheme and a fusing scheme for the multidimensional quantum error detection graph based at least in part on a decoding latency and a fusion latency;
partitioning the multidimensional quantum error detection graph into a plurality of blocks based at least in part on the partitioning scheme;
decoding each of the plurality of blocks; and
fusing the plurality of blocks into a decoded detection graph based at least in part on the fusing scheme.

14. The quantum computing system of claim 13, wherein the surface code comprises a plurality of measurement qubits and a plurality of data qubits.

15. The quantum computing system of claim 13, wherein the operation of determining a partitioning scheme and a fusing scheme comprises:
generating a plurality of fusion tree data structures, each fusion tree data structure comprising data indicative of a candidate partitioning scheme and data indicative of a candidate fusing scheme associated with the candidate partitioning scheme;
selecting one of the plurality of fusion tree data structures as a selected fusion tree data structure based on a latency associated with the candidate partitioning scheme and a latency associated with the candidate fusing scheme; and
determining the partitioning scheme and the fusing scheme for the multidimensional quantum error detection graph based at least in part on the selected fusion tree data structure.

16. The quantum computing system of claim 13, wherein the partitioning scheme partitions the multidimensional quantum error detection graph in a time dimension.

17. The quantum computing system of claim 13, wherein the partitioning scheme partitions the multidimensional quantum error detection graph in one or more spatial dimensions.

18. One or more non-transitory computer-readable media storing computer-readable instructions that when executed by one or more processors cause the one or more processors to perform operations, comprising:
generating a plurality of fusion tree data structures, each fusion tree data structure comprising data indicative of a candidate partitioning scheme for a multidimensional quantum error detection graph of a quantum computing system and data indicative of a candidate fusing scheme associated with the candidate partitioning scheme;
selecting one of the plurality of fusion tree data structures as a selected fusion tree data structure based on a latency associated with the candidate partitioning scheme and a latency associated with the candidate fusing scheme; and
determining a partitioning scheme and a fusing scheme for the multidimensional quantum error detection graph based at least in part on the selected fusion tree data structure.

19. The one or more non-transitory computer-readable media of claim 18, wherein selecting one of the plurality of fusion tree data structures as a selected fusion tree data structure is implemented, at least in part, using dynamic programming.

20. The one or more non-transitory computer-readable media of claim 18, wherein the data indicative of the candidate fusing scheme is represented in a tree data structure, wherein the tree data structure comprises a plurality of leaf nodes, each of the plurality of leaf nodes representing one of a plurality of blocks associated with the candidate partitioning scheme, the tree data structure comprising one or more nodes representing a fusing of two or more of the plurality of blocks associated with the candidate partitioning scheme.
